(19) United States
(12) Patent Application Publication
(10) Pub. No.: US 2024/0403048 A1
(43) Pub. Date: Dec. 5, 2024

(54) CATEGORIZED MEMORY OPERATIONS FOR SELECTIVE MEMORY FLUSHING

(71) Applicant: NVIDIA CORPORATION, Santa Clara, CA (US)

(72) Inventors: Kaushal AGARWAL, Bengaluru (IN); Jonathon Stuart Ramsay EVANS, Santa Clara, CA (US)

(21) Appl. No.: 18/325,806

(22) Filed: May 30, 2023

(51) Int. Cl. G06F 9/30; G06F 9/52

(52) U.S. Cl. CPC G06F 9/30047; G06F 9/30189; G06F 9/522

(57) ABSTRACT

Various embodiments include techniques for launching processing work in a computing system. The disclosed techniques include load and store operations that specify a category. The disclosed techniques further include barrier instructions that specify a category. A processing unit of the computing system executes a set of load and store operations that specify various categories. When the processor subsequently executes a barrier instruction that specifies a category, the barrier instruction waits for data for only load and store operations that specify the same category. After the barrier instruction completes execution, the processing unit can launch processes that are dependent on data from load and store operations of the specified category, even if data from load and store operations of other categories is still pending. As a result, the processing unit can launch processes as soon as the relevant data is available without waiting for nonrelevant data.

### BACKGROUND

### Field of the Various Embodiments

Various embodiments relate generally to computing system architectures and, more specifically, to categorized memory operations for selective memory flushing.

### Description of the Related Art

A computing system generally includes, among other things, one or more processing units, such as central processing units (CPUs) and/or graphics processing units (GPUs), network adapters, and one or more memory systems. Processing units execute user mode software applications, which submit and launch compute tasks, executing on one or more compute engines included in the processing units. In operation, processing units load data from the one or more memory systems, perform various arithmetic and logical operations on the data, and store data back to the one or more memory systems. In some examples, one of the processing units, referred to as the host, generates input data to be used as input for one or more processes, referred to as work, and stores the input data to host memory. The host launches the work to another processing unit, such as a GPU, or another component, such a network adapter. This other processing unit or other component is referred to as an auxiliary processor. When the host launches the work, the host sets a flag in a remote memory that is readable by the auxiliary processor. When the auxiliary processor detects that the flag is set, the auxiliary processor executes the work and generates output data. The auxiliary processor stores the output data in host memory and clears the flag. Upon detecting that the flag is clear, the host and/or another auxiliary processor accesses the output data.

In some examples, memory operations can execute out of order, such that the flag could be set in auxiliary processor-accessible memory before all the input data is stored to host memory. In such cases, the auxiliary processor could begin to execute the work before all the input data is stored in host memory. To avoid this possibility, the host inserts a memory barrier instruction after the instructions for the memory operations that store the input data and before the instruction that sets the flag in remote memory. The barrier instruction ensures that the input data stored by the memory operations is visible in host memory before any instruction after the barrier instruction executes.

In a typical scenario, the host generates first input data for a first set of work and executes memory operations to store the first input data in host memory. The host executes a barrier instruction and waits for an indication that the first input data is visible in host memory. After receiving the indication that the first input data is visible, the host sets a flag in auxiliary processor-accessible memory and begins to generate and store second input data for a second set of work. Meanwhile, in response to detecting that the flag is set, the auxiliary processor accesses the first input data and executes the first set of work associated with the first input data. Upon completing the first set of work, the auxiliary processor stores first output data in host memory and clears the flag. In response to detecting that the flag is clear, the host accesses the first output data and/or completes the storing of the second input data. The host executes a barrier instruction and waits for an indication that the second input data is visible in host memory. After receiving the indication that the second input data is visible, the host sets a flag in auxiliary processor-accessible memory and begins to generate and store third input data for a third set of work. Meanwhile, in response to detecting that the flag is set, the auxiliary processor accesses the second input data and executes the second set of work associated with the second input data. Upon completing the second set of work, the auxiliary processor stores second output data in host memory and clears the flag. In response to detecting that the flag is clear, the host accesses the second output data and/or completes the storing of the third input data. The host repeats this process for the third set of work, a fourth set of work, a fifth set of work, and so on.

One problem with this technique for executing work in a computing system is that the host barrier waits for all previous data and flags to be visible. This can create false dependencies between each task sent to the auxiliary processor. Each barrier need only order data between the input data and flag of each set of work. This prevents the system from recording the next set of work in parallel with the first.

Further, part of the process of completing execution of the first set of work involves the host setting a flag in auxiliary processor-accessible memory. In some systems, setting a flag in a remote memory can take a significant amount of time relative to storing data in host memory. As a result, the execution of the second set of work can be significantly, and needlessly, delayed, resulting in reduced computational performance.

Conventional approaches to solve this problem involve optimizing the latency of the operation where the host writes the flag to the remote memory. This latency can be orders of magnitude longer than the latency of memory operations where the host stores data in host memory. However, these conventional approaches are limited by the fact that the latency of remote memory operations to remote memory is inherently longer than local memory operations to host memory. As a result, even with reduced latency, the host still must wait, sometimes needlessly, for one set of work to complete execution before launching another set of work, even if the two sets of work are independent from one another.

As the foregoing illustrates, what is needed in the art are more effective techniques for launching processing work in a computing system.

### SUMMARY

Various embodiments of the present disclosure set forth a computer-implemented method for launching processing work in a computing system. The method includes executing a first memory operation that specifies a first category. The method further includes executing a first barrier instruction that specifies the first category. The method further includes determining that data associated with memory operations that specify the first category, including the first memory operation, is visible in a memory. The method further includes, subsequent to determining that the data associated with the first memory operation is visible in the memory, launching a first process to execute on an auxiliary processor while a second memory operation is pending, wherein the first process accesses the data associated with the first memory operation

Other embodiments include, without limitation, a system that implements one or more aspects of the disclosed techniques, and one or more computer readable media including instructions for performing one or more aspects of the disclosed techniques.

At least one technical advantage of the disclosed techniques relative to the prior art is that, with the disclosed techniques, a processor does not wait until a first set of work completes execution or being launched prior to launching a second set of independent work. Instead, with the disclosed techniques, the time to launch work is constrained by the time to generate and store input data for various sets of work in host memory. Further, the time to execute work is not constrained, and is independent of, completion of execution of prior sets of work, including setting a flag in remote memory for those prior sets of work. As a result, work is launched and executed with decreased latency relative to prior conventional techniques. This decreased latency leads to higher computational performance relative to prior techniques. These advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system configured to implement one or more aspects of the various embodiments;

FIG. 2 is a block diagram of a parallel processing unit (PPU) included in the auxiliary processor processing subsystem of FIG. 1, according to various embodiments;

FIG. 3 is a block diagram of a general processing cluster (GPC) included in the parallel processing unit (PPU) of FIG. 2, according to various embodiments;

FIG. 4 is a sequence diagram of launching sets of interdependent work to an auxiliary processor included in the computing system of FIG. 1, according to various embodiments;

FIG. 5 is a sequence diagram of launching sets of independent work to an auxiliary processor included in the computing system of FIG. 1, according to various embodiments; and

FIGS. 6A-6B set forth a flow diagram of method steps for launching processing work in the computing system of FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

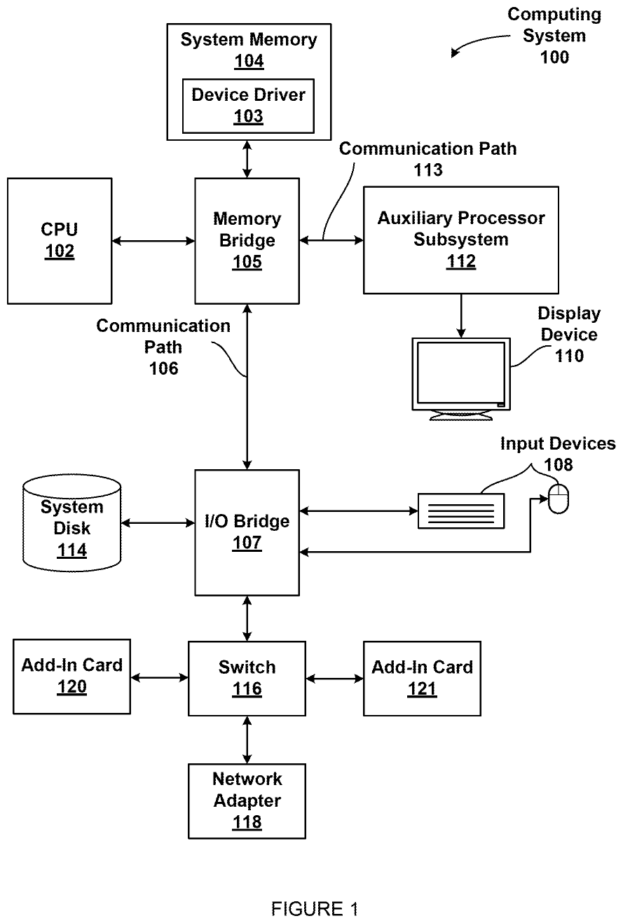

FIG. 1 is a block diagram of a computing system 100 configured to implement one or more aspects of the various embodiments. As shown, computing system 100 includes, without limitation, a central processing unit (CPU) 102 and a system memory 104 coupled to an auxiliary processor subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. In some examples, input devices 108 are employed to verify the identities of one or more users in order to permit access of computing system 100 to authorized users and deny access of computing system 100 to unauthorized users. Switch 116 is configured to provide connections between I/O bridge 107 and other components of the computing system 100, such as a network adapter 118 and various add-in cards 120 and 121. In some examples, network adapter 118 serves as the primary or exclusive input device to receive input data for processing via the disclosed techniques.

As also shown, I/O bridge 107 is coupled to a system disk 114 that may be configured to store content and applications and data for use by CPU 102 and auxiliary processor subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, Peripheral Component Interconnect Express (PCIe), HyperTransport, or any other bus or point-to-point communication protocol known in the art.

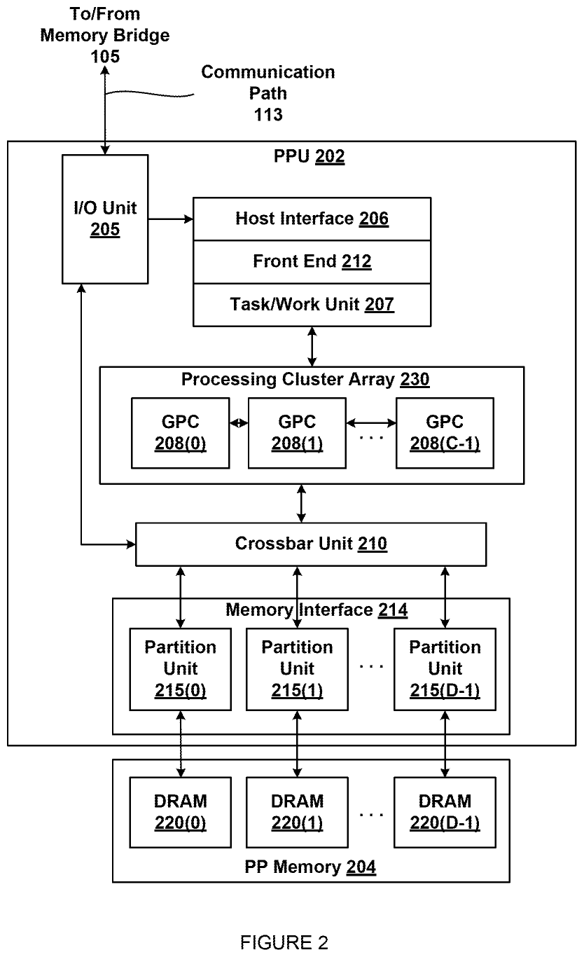

In some embodiments, auxiliary processor subsystem 112 comprises a graphics subsystem that delivers pixels to a display device 110 that may be any conventional cathode ray tube, liquid crystal display, light-emitting diode display, or the like. In such embodiments, the auxiliary processor subsystem 112 incorporates circuitry optimized for graphics and video processing, including, for example, video output circuitry. As described in greater detail below in FIG. 2, such circuitry may be incorporated across one or more auxiliary processors included within auxiliary processor subsystem 112. An auxiliary processor includes any one or more processing units that can execute instructions such as a central processing unit (CPU), a parallel processing unit (PPU) of FIGS. 2-4, a graphics processing unit (GPU), a direct memory access (DMA) unit, an intelligence processing unit (IPU), neural processing unit (NAU), tensor processing unit (TPU), neural network processor (NNP), a data processing unit (DPU), a vision processing unit (VPU), an application specific integrated circuit (ASIC), a field-programmable gate array (FPGA), and/or the like.

In some embodiments, auxiliary processor subsystem 112 includes two processors, referred to herein as a primary processor (normally a CPU) and a secondary processor. Typically, the primary processor is a CPU and the secondary processor is a GPU. Additionally or alternatively, each of the primary processor and the secondary processor may be any one or more of the types of auxiliary processors disclosed herein, in any technically feasible combination. The secondary processor receives secure commands from the primary processor via a communication path that is not secured. The secondary processor accesses a memory and/or other storage system, such as such as system memory 104, Compute eXpress Link (CXL) memory expanders, memory managed disk storage, on-chip memory, and/or the like. The secondary processor accesses this memory and/or other storage system across an insecure connection. The primary processor and the secondary processor may communicate with one another via a GPU-to-GPU communications channel, such as Nvidia Link (NVLink). Further, the primary processor and the secondary processor may communicate with one another via network adapter 118. In general, the distinction between an insecure communication path and a secure communication path is application dependent. A particular application program generally considers communications within a die or package to be secure. Communications of unencrypted data over a standard communications channel, such as PCIe, are considered to be unsecure.

In some embodiments, the auxiliary processor subsystem 112 incorporates circuitry optimized for general purpose and/or compute processing. Again, such circuitry may be incorporated across one or more auxiliary processors included within auxiliary processor subsystem 112 that are configured to perform such general purpose and/or compute operations. In yet other embodiments, the one or more auxiliary processors included within auxiliary processor subsystem 112 may be configured to perform graphics processing, general purpose processing, and compute processing operations. System memory 104 includes at least one device driver 103 configured to manage the processing operations of the one or more auxiliary processors within auxiliary processor subsystem 112.

In various embodiments, auxiliary processor subsystem 112 may be integrated with one or more other the other elements of FIG. 1 to form a single system. For example, auxiliary processor subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of auxiliary processor subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, auxiliary processor subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the auxiliary processor subsystem 112 of FIG. 1, according to various embodiments. Although FIG. 2 depicts one PPU 202, as indicated above, auxiliary processor subsystem 112 may include any number of PPUs 202. Further, the PPU 202 of FIG. 2 is one example of an auxiliary processor included in auxiliary processor subsystem 112 of FIG. 1. Alternative auxiliary processors include, without limitation, CPUs, GPUs, DMA units, IPUs, NPUs, TPUs, NNPs, DPUs, VPUs, ASICs, FPGAs, and/or the like. The techniques disclosed in FIGS. 2-4 with respect to PPU 202 apply equally to any type of auxiliary processor(s) included within auxiliary processor subsystem 112, in any combination. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computing system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. Additionally or alternatively, processors and/or auxiliary processors other than CPU 102 may write one or more streams of commands for PPU 202 to a data structure. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computing system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computing system 100 may be varied. In some embodiments, auxiliary processor subsystem 112, which includes at least one PPU 202, is implemented as an add-in card that can be inserted into an expansion slot of computing system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≥1. Each partition unit 215 is coupled to one or more dynamic random access memories (DRAMs) 220 residing within PP memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPC 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity, and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within auxiliary processor subsystem 112, or another auxiliary processor subsystem 112 within computing system 100.

As noted above, any number of PPUs 202 may be included in an auxiliary processor subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

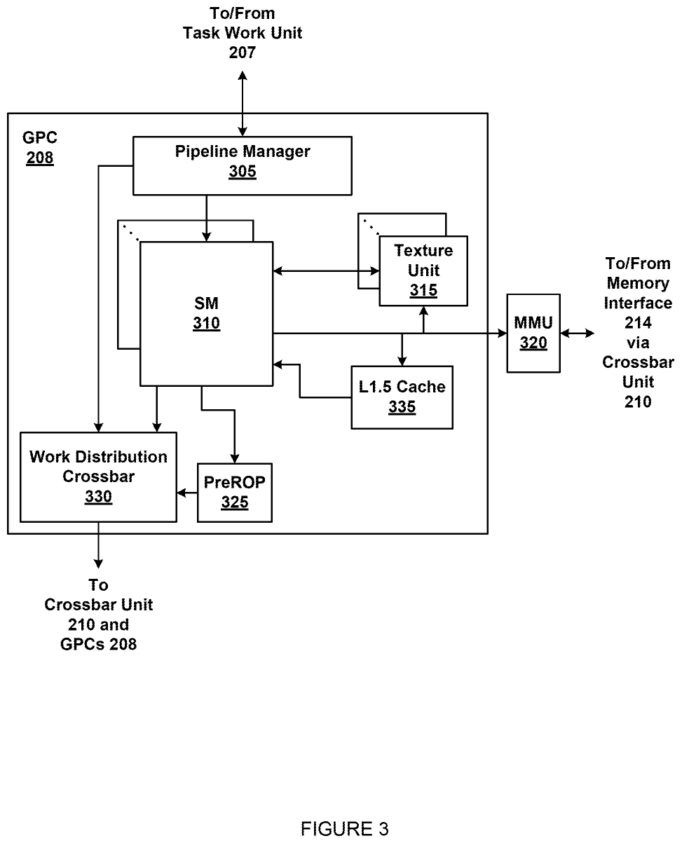

FIG. 3 is a block diagram of a general processing cluster (GPC) 208 included in the parallel processing unit (PPU) 202 of FIG. 2, according to various embodiments. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (e.g., AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m′k, where k is the number of concurrently executing threads in a thread group, which is typically an integer multiple of the number of execution units within the SM 310, and m is the number of thread groups simultaneously active within the SM 310. In various embodiments, a software application written in the compute unified device architecture (CUDA) programming language describes the behavior and operation of threads executing on GPC 208, including any of the above-described behaviors and operations. A given processing task may be specified in a CUDA program such that the SM 310 may be configured to perform and/or manage general-purpose compute operations.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the various embodiments of the present disclosure.

Please note, as used herein, references to shared memory may include any one or more technically feasible memories, including, without limitation, a local memory shared by one or more SMs 310, or a memory accessible via the memory interface 214, such as a cache memory, parallel processing memory 204, or system memory 104. Please also note, as used herein, references to cache memory may include any one or more technically feasible memories, including, without limitation, an L1 cache, an L1.5 cache, and the L2 caches.

### Launching Work Using Categorized Memory Operations and Barrier Instructions

Various embodiments include techniques for launching processing work in a computing system. Processing units in a multiprocessor system execute memory operations and barrier instructions that can be associated with a category. The disclosed techniques include adding a new set of instructions to the instruction set architecture (ISA). The new set of instructions includes categorized memory operations. These memory operation instructions include, and are associated with, an optional category to be added as a modifier to certain load instructions and/or store instructions. The new set of instructions further includes categorized barrier instructions. These barrier instructions also include, and are associated with, an optional category to be added as a modifier to certain barrier instructions. When the processor executes a barrier instruction associated with a particular category, the processor waits until all prior load instructions and store instructions associated with the same category as the barrier instruction have completed execution. Additionally or alternatively, the processor waits until the data associated with all prior load instructions and store instructions associated with the same category as the barrier instruction is visible in host memory, also referred to herein as local memory. In some examples, the processor is CPU 102 and host memory is the system memory 104 of the computing system 100 of FIG. 1. However, the processor does not wait for prior load instructions and store instructions associated with a different category, or associated with no category, to complete execution.

If the processor executes a categorized load operation or a categorized store operation that does not specify a particular category, then the processor executes the load operation or store operation as a categorized memory operation that specifies a default category. Subsequently, if the processor executes a categorized barrier instruction that does not specify a category, or a categorized barrier instruction that specifies the default category, then the processor waits until the data associated with load operations and store operations associated with the default category is visible in host memory. The processor continues to support legacy barrier instructions that do not specify a particular category. If the processor executes such a legacy barrier instruction, then the processor waits until the data associated with all load operations and all store operations is visible in host memory, including data from legacy memory operations, data from categorized memory operations that specify a category, and/or categorized memory operations that do not specify a category. As used herein, legacy memory operations, including legacy load operations and legacy store operations, are also referred to as standard memory operations or uncategorized memory operations. Similarly, legacy barrier instructions are also referred to as standard barrier instructions or uncategorized barrier instructions.

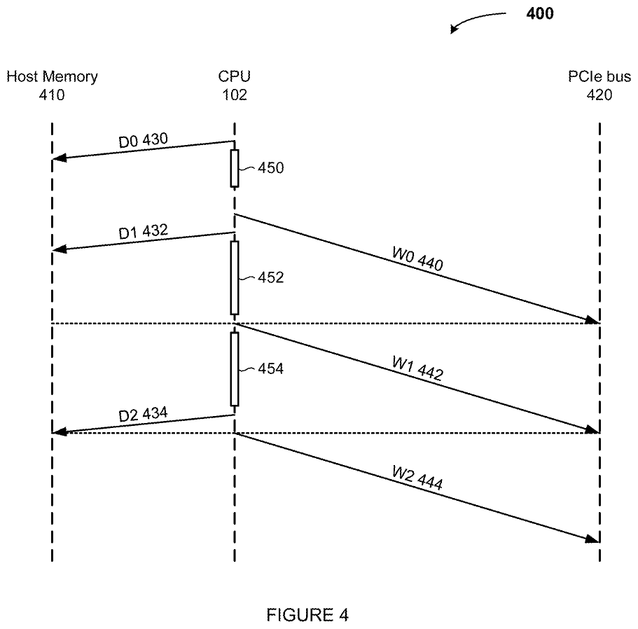

FIG. 4 is a sequence diagram of launching sets of interdependent work to an auxiliary processor included in the computing system of FIG. 1, according to various embodiments. In some examples, CPU 102 launches multiple sets of interdependent work to an auxiliary processor that is accessible to CPU 102 via a remote communications channel, such as a peripheral component interface express (PCIe) bus 420. The remote auxiliary processor can be the auxiliary processor subsystem 112, the network adapter 118, and/or the like.

As shown, CPU 102 executes instructions to generate first input data (DO) 430 and to store the first input data 430 in host memory 410. Host memory 410 can include system memory 104, PP memory 204, L1 cache, L1.5 cache 335, L2 cache, and/or the like, in any combination. CPU 102 stores the first input data 430 in host memory 410 by executing legacy store instructions that do not include a category. Additionally or alternatively, CPU 102 stores the first input data 430 in host memory 410 by executing categorized store instructions that do not specify a particular category. In this latter case, CPU 102 treats the store instructions as categorized store instructions that specify the default category.

CPU 102 executes additional instructions 450, where the additional instructions include a barrier instruction. This barrier instruction can be a legacy barrier instruction that does not include a category. Alternatively, this barrier instruction can be a categorized barrier instruction that does not specify a particular category. In this latter case, CPU 102 treats the barrier instruction as a categorized barrier instruction that specifies the default category. If the barrier instruction is a legacy barrier instruction, then the barrier instruction waits until the data from all memory operations is visible in host memory 410. Otherwise, the barrier instruction waits until the data from all memory operations that specify and/or are deemed to specify, the default category is visible in host memory 410. Because CPU 102 stored the first input data 430 with memory operations that are deemed to specify the default category, the barrier instruction waits until the first input data 430 is visible in host memory 410. The barrier instruction then completes, and CPU 102 subsequently sets a flag in auxiliary processor-accessible memory (not shown). The auxiliary processor-accessible memory can be a memory and/or one or more registers that are accessible via the PCIe bus 420. By setting the flag, CPU 102 launches a first set of work (W0) 440 to the auxiliary processor via the PCIe bus 420.

After launching the first set of work 440, and while the first set of work 440 is pending, CPU 102 executes instructions to generate second input data (D1) 432 and to store the second input data 432 in host memory 410. CPU 102 stores the second input data 432 in host memory 410 by executing legacy store instructions and/or by executing categorized store instructions that do not specify a particular category.

CPU 102 executes additional instructions 452, where the additional instructions include a barrier instruction. This barrier instruction can be a legacy barrier instruction that does not include a categorized barrier instruction that does not specify a particular category. If the barrier instruction is a legacy barrier instruction, then the barrier instruction waits until the data from all memory operations is visible in host memory 410. Otherwise, the barrier instruction waits until the data from all memory operations that specify, and/or are deemed to specify, the default category is visible in host memory 410. Because CPU 102 stored the second input data 432 with memory operations that are deemed to specify the default category, the barrier instruction waits until the second input data 432 is visible in host memory 410. The barrier instruction then completes, and CPU 102 subsequently sets a flag in auxiliary processor-accessible memory. By setting the flag, CPU 102 launches a second set of work (W1) 442 to the auxiliary processor via the PCIe bus 420.

After launching the second set of work 442, and while the second set of work 442 is pending, CPU 102 executes instructions to generate third input data (D2) 434 and to store the third input data 434 in host memory 410. CPU 102 stores the third input data 434 in host memory 410 by executing legacy store instructions and/or by executing categorized store instructions that do not specify a particular category.

CPU 102 executes additional instructions 454, where the additional instructions include a barrier instruction. This barrier instruction can be a legacy barrier instruction that does not include a category or a categorized barrier instruction that does not specify a particular category. If the barrier instruction is a legacy barrier instruction, then the barrier instruction waits until the data from all memory operations is visible in host memory 410. Otherwise, the barrier instruction waits until the data from all memory operations that specify and/or are deemed to specify, the default category is visible in host memory 410. Because CPU 102 stored the third input data 434 with memory operations that are deemed to specify the default category, the barrier instruction waits until the third input data 434 is visible in host memory 410. The barrier instruction then completes, and CPU 102 subsequently sets a flag in auxiliary processor-accessible memory. By setting the flag, CPU 102 launches a third set of work (W2) 444 to the auxiliary processor via the PCIe bus 420.

In this manner, CPU 102 launches consecutive sets of interdependent work to an auxiliary processor by waiting until a current set of work has been launched before launching subsequent sets of work. As a result, input data from the current set of work is visible in host memory 410 and can be accessed reliably as input data for subsequent sets of work.

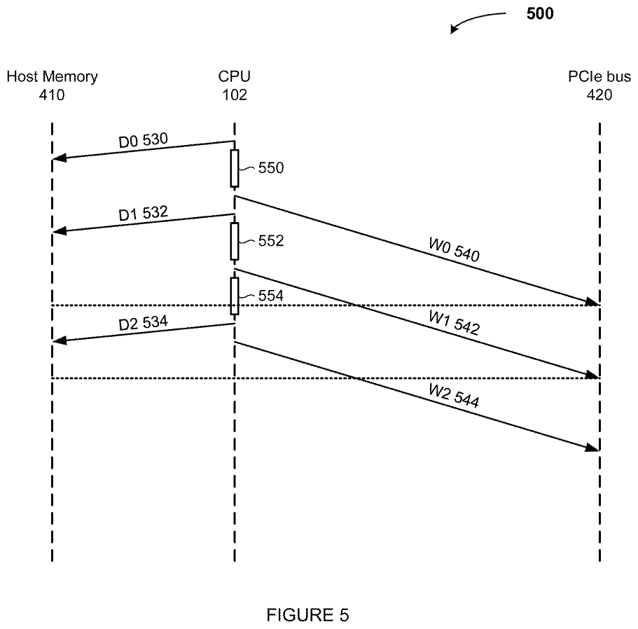

FIG. 5 is a sequence diagram of launching sets of independent work to an auxiliary processor included in the computing system of FIG. 1, according to various embodiments. In some examples, CPU 102 launches multiple sets of independent work to an auxiliary processor that is accessible to CPU 102 via a remote communications channel, such as a peripheral component interface express (PCIe) bus 420. The remote auxiliary processor can be the auxiliary processor subsystem 112, the network adapter 118, and/or the like.

As shown, CPU 102 executes instructions to generate first input data (DO) 530 and to store the first input data 530 in host memory 410. Host memory 410 can include system memory 104, PP memory 204, L1 cache, L1.5 cache 335, L2 cache, and/or the like, in any combination. CPU 102 stores the first input data 530 in host memory 410 by executing categorized store instructions that specify a first category.

CPU 102 executes additional instructions 550, where the additional instructions include a barrier instruction. This barrier instruction is a categorized barrier instruction that specifies the first category. The barrier instruction waits until the data from all memory operations that specify the default category is visible in host memory 410. The barrier instruction does not wait until the data from all memory operations that specify categories other than the first category is visible in host memory 410. Because CPU 102 stored the first input data 530 with memory operations that specify the first category, the barrier instruction waits until the first input data 530 is visible in host memory 410, but does not wait until other data is visible in host memory 410. The barrier instruction then completes, and CPU 102 subsequently sets a flag in auxiliary processor-accessible memory (not shown). The auxiliary processor-accessible memory can be a memory and/or one or more registers that are accessible via the PCIe bus 420. By setting the flag, CPU 102 launches a first set of work (W0) 540 to the auxiliary processor via the PCIe bus 420. In some embodiments, setting the flag is considered to be equivalent to launching this first set of work to the auxiliary processor.

After launching the first set of work 540, and while the first set of work 540 is pending, CPU 102 executes instructions to generate second input data (D1) 532 and to store the second input data 532 in host memory 410. CPU 102 stores the second input data 532 in host memory 410 by executing categorized store instructions that specify a second category.

CPU 102 executes additional instructions 552, where the additional instructions include a barrier instruction. This barrier instruction is a categorized barrier instruction that specifies a second category. The barrier instruction waits until the data from all memory operations that specify the second category is visible in host memory 410. Because CPU 102 stored the second input data 532 with memory operations that specify the second category, the barrier instruction waits until the second input data 532 is visible in host memory 410 but does not wait until other data is visible in host memory 410. The barrier instruction then completes, and CPU 102 subsequently sets a flag in auxiliary processor-accessible memory. By setting the flag, CPU 102 launches a second set of work (W1) 542 to the auxiliary processor via the PCIe bus 420. Because the barrier instruction does not wait until the first input data 530, stored with memory operations that specify the first category, is visible in host memory 410, CPU 102 can set the flag and can launch the second set of work 542 while the first set of work 540 is still pending.

After launching the second set of work 542, and while the second set of work 540 is pending, CPU 102 executes instructions to generate third input data (D1) 534 and to store the third input data 534 in host memory 410. CPU 102 stores the third input data 534 in host memory 410 by executing categorized store instructions that specify a third category.

CPU 102 executes additional instructions 554, where the additional instructions include a barrier instruction. This barrier instruction is a categorized barrier instruction that specifies a third category. The barrier instruction waits until the data from all memory operations that specify the third category is visible in host memory 410. Because CPU 102 stored the third input data 534 with memory operations that specify the third category, the barrier instruction waits until the third input data 534 is visible in host memory 410 but does not wait until other data is visible in host memory 410. The barrier instruction then completes, and CPU 102 subsequently sets a flag in auxiliary processor-accessible memory. By setting the flag, CPU 102 launches a third set of work (W2) 544 to the auxiliary processor via the PCIe bus 420. Because the barrier instruction does not wait until the second input data 532, stored with memory operations that specify the second category, is visible in host memory 410, CPU 102 can set the flag and can launch the third set of work 544 while the second set of work 542 is still pending. Similarly, because the barrier instruction does not wait until the first input data 530, stored with memory operations that specify the first category, is visible in host memory 410, CPU 102 can set the flag and can launch the third set of work 544 while the first set of work 540 is still pending.

In this manner, CPU 102 launches consecutive sets of independent work to an auxiliary processor without waiting for currently pending sets to complete launching or execution before launching subsequent sets of work. Because the sets of work are independent, output data from the current set of work is not accessed as input data for subsequent sets of work. By launching consecutive sets of work without waiting for independent and pending sets of work to complete, the sets of work are executed with reduced latency and higher computational performance relative to conventional techniques.

It will be appreciated that the system shown herein is illustrative and that variations and modifications are possible. The techniques described herein are in the context of a CPU 102 when synchronizing the launching of work to an auxiliary processor subsystem 112 using categorized memory operations and barrier instructions. Additionally or alternatively, the techniques described herein can be used for synchronizing other types of operations performed by multiple processors. In so doing, the CPU 102 synchronizes operations by setting a flag to enable a process to execute on the auxiliary processor subsystem 112. In some examples, the techniques described herein can be used for synchronizing data structures between two or more CPUs 102 using categorized memory operations and barrier instructions. Additionally or alternatively, the techniques described herein can be used for synchronizing data structures between two or more auxiliary processor subsystems 112 using categorized memory operations and barrier instructions. The disclosed techniques can be used to by various applications and/or processes to synchronize data stored in data structures located in near memory and/or data structures located in far memory. As used herein, near memory refers to memory that is physically near to the CPU 102 and/or near to the auxiliary processor subsystem 112. The CPU 102 and/or the auxiliary processor subsystem 112 accesses near memory with relatively low latency. structures located in near memory and/or data structures located in far memory. As used herein, far memory refers to memory that is physically far away from the CPU 102 and/or far away from the auxiliary processor subsystem 112. The CPU 102 and/or the auxiliary processor subsystem 112 accesses far memory with relatively high latency.

The techniques described herein are in the context of a CPU 102 serving as a host and configured to launch work to an auxiliary processor, such as the auxiliary processor subsystem 112, the network adapter 118, and/or the like. Additionally or alternatively, the techniques described herein can be performed by one or more processing units including, without limitation, CPUs, GPUs, DMA units, IPUs, NPUs, TPUs, NNPs, DPUs, VPUs, ASICs, FPGAs, and/or the like, in any combination. Further, the techniques described herein can be directed towards any one or more processing units including, without limitation, CPUs, GPUs, DMA units, IPUs, NPUs, TPUs, NNPs, DPUs, VPUs, ASICs, FPGAs, and/or the like, in any combination. More generally, the techniques described herein can be applied to any CPU 102, PPU 202, and/or any other processing unit in any combination. In addition, the techniques are described in the context of a host that stores input data in host memory 410 and an auxiliary processor that stores output data in this host memory 410. This host memory 410 can include any memory within the computing system 100, such as system memory 104, PP memory 204, L1 cache, L1.5 cache 335, L2 cache, and/or the like, in any combination.

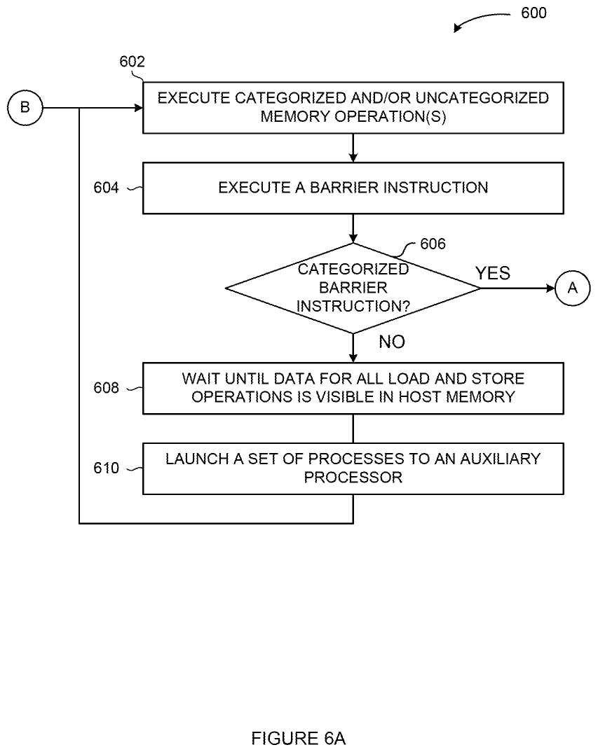

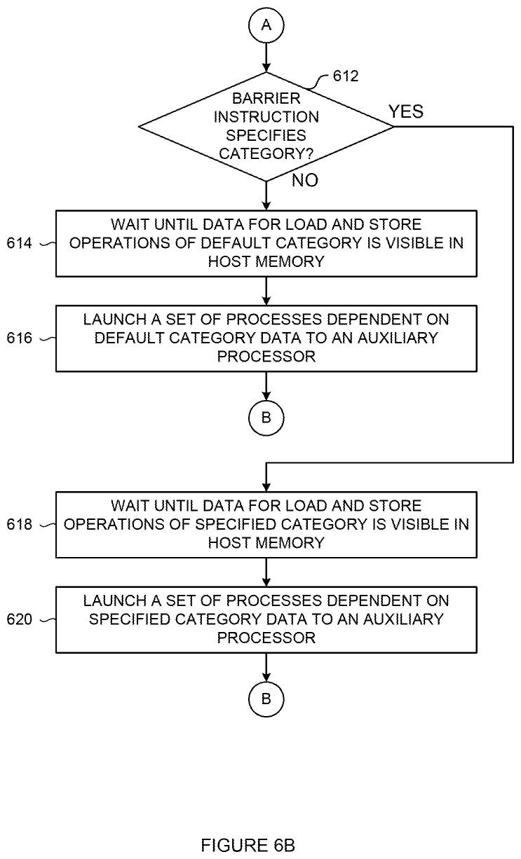

FIGS. 6A-6B set forth a flow diagram of method steps for launching processing work in the computing system 100 of FIG. 1, according to various embodiments. The method steps can be performed by CPU 102, auxiliary processor subsystem 112, and/or the like. Additionally or alternatively, the method steps can be performed by one or more processing units and/or alternative auxiliary processors including, without limitation, CPUs, GPUs, DMA units, IPUs, NPUs, TPUs, NNPs, DPUs, VPUs, ASICs, FPGAs, and/or the like, in any combination. Although the method steps are described in conjunction with the systems of FIGS. 1-5, persons of ordinary skill in the art will understand that any system configured to perform the method steps, in any order, is within the scope of the present disclosure.

As shown, a method 600 begins at step 602, where a processing unit executes one or more categorized and/or uncategorized memory operations. Categorized memory operations specify a particular category that can be subsequently used by categorized barrier instructions. In some cases, categorized memory operations do not specify a particular category. Such categorized memory instructions are deemed to specify the default category. Uncategorized memory operations include legacy load operations and legacy store operations that do not specify a category.

At step 604, the processing unit executes a barrier instruction. The barrier instruction could be a categorized barrier instruction that specifies a particular category (including the default category), a categorized barrier instruction that does not specify a particular category, or an uncategorized barrier instruction.

At step 606, the processing unit determines whether the barrier instruction is a categorized barrier instruction. If the barrier instruction is not a categorized barrier instruction, then the method 600 proceeds to step 608, where the processing unit waits until data for all load operations and store operations is visible in host memory. In particular, the processing unit waits for data for categorized load and categorized store operations that specify a particular category (including the default category), categorized load and categorized store operations that do not specify a particular category, and uncategorized load and uncategorized store operations. When the processing unit completes execution of uncategorized barrier instruction, data from all pending memory operations is visible in host memory. At step 610, the processing unit launches a set of processes to an auxiliary processor. Because all data is visible in the host memory, the auxiliary processor can reliably access any data resident in host memory as input data for the set of processes. The method 600 then proceeds to step 602, described above, to process additional memory operations.

Returning to step 606, if the barrier instruction is a categorized barrier instruction, then the method 600 proceeds to step 612, where the processing unit determines whether the categorized barrier instruction specifies a particular category. If the categorized barrier instruction does not specify a category, then the method 600 proceeds to step 614, where the processing unit waits until data for categorized load operations and categorized store operations of the default category is visible in host memory. Categorized load operations and categorized store operations that do not specify a particular category are deemed to specify the default category. In particular, the processing unit waits for data for categorized load and categorized store operations that specify, or are deemed to specify, the default category. When the processing unit completes execution of such a categorized barrier instruction, data from all pending memory operations that specify, or are deemed to specify, the default category is visible in host memory. At step 616, the processing unit launches a set of processes dependent on the default category to an auxiliary processor. Because all data from memory operations of the default category is visible in the host memory, the auxiliary processor can reliably access any data resident in host memory resulting from such memory operations as input data for the set of processes. Data from uncategorized memory operations and/or from categorized memory operations that specify categories other than the default category are not reliably accessed as input data for the set of processes. The method 600 then proceeds to step 602, described above, to process additional memory operations.

Returning to step 612, if the barrier instruction is a categorized barrier instruction, then the method 600 proceeds to step 618, where the processing unit waits until data for categorized load operations and categorized store operations of the specified category is visible in host memory. When the processing unit completes execution of such a categorized barrier instruction, data from all pending memory operations of the specified category is visible in host memory. At step 620, the processing unit launches a set of processes dependent on the specified category to an auxiliary processor. Because all data from memory operations of the specified category is visible in the host memory, the auxiliary processor can reliably access any data resident in host memory resulting from such memory operations as input data for the set of processes. Data from uncategorized memory operations and/or from categorized memory operations that specify categories other than the specified category are not reliably accessed as input data for the set of processes. The method 600 then proceeds to step 602, described above, to process additional memory operations.

In sum, various embodiments include techniques for launching processing work in a computing system. Processing units in a multiprocessor system execute memory operations and barrier instructions that can be associated with a category, also referred to herein as a category. The disclosed techniques include adding a new set of instructions to the instruction set architecture. The new set of instructions includes categorized, or categorized, memory operations. These memory operation instructions include, and are associated with, an optional category or category to be added as a modifier to certain load instructions and/or store instructions. The new set of instructions further includes categorized barrier instructions. These barrier instructions also include, and are associated with, an optional category to be added as a modifier to certain barrier instructions. When the processor executes a barrier instruction associated with a particular category, the processor waits until all prior load instructions and store instructions associated with the same category as the barrier instruction have completed execution. Additionally or alternatively, the processor waits until the data associated with all prior load instructions and store instructions associated with the same category as the barrier instruction is visible in host memory. However, the processor does not wait for prior load instructions and store instructions associated with a different category, or associated with no category, to complete execution.

If the processor executes a categorized load operation or a categorized store operation that does not specify a particular category, then the processor executes the load operation or store operation as a categorized memory operation that specifies a default category. Subsequently, if the processor executes a categorized barrier instruction that does not specify a category, or a categorized barrier instruction that specifies the default category, then the processor waits until the data associated with load operations and store operations associated with the default category is visible in host memory. The processor continues to support legacy barrier instructions that do not specify a particular category. If the processor executes such a legacy barrier instruction, then the processor waits until the data associated with all load operations and all store operations is visible in host memory, including data from legacy memory operations, data from categorized memory operations that specify a category, and/or categorized memory operations that do not specify a category.

At least one technical advantage of the disclosed techniques relative to the prior art is that, with the disclosed techniques, a processor does not wait until a first set of work completes execution or being launched prior to launching a second set of independent work. Instead, with the disclosed techniques, the time to launch work is constrained by the time to generate and store input data for various sets of work in host memory. Further, the time to execute work is not constrained, and is independent of, completion of execution of prior sets of work, including setting a flag in remote memory for those prior sets of work. As a result, work is launched and executed with decreased latency relative to prior conventional techniques. This decreased latency leads to higher computational performance relative to prior techniques. These advantages represent one or more technological improvements over prior art approaches.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for synchronizing processing work in a computing system, the method comprising:
executing a first memory operation that specifies a first category;
executing a first barrier instruction that specifies the first category;
determining that data associated with memory operations that specify the first category, including the first memory operation, is visible in a memory; and
subsequent to determining that the data associated with the first memory operation is visible in the memory, setting a flag to enable a first process to execute on a processor while a second memory operation is pending, wherein the first process accesses the data associated with the first memory operation.

2. The computer-implemented method of claim 1, wherein the second memory operation specifies a second category that is different from the first category.

3. The computer-implemented method of claim 1, wherein the second memory operation does not specify a category.

4. The computer-implemented method of claim 1, wherein the second memory operation does not specify a category, and wherein the second memory operation is deemed to specify a default category that is different from the first category.

5. The computer-implemented method of claim 1, wherein the second memory operation specifies a default category that is different from the first category.

6. The computer-implemented method of claim 1, further comprising:
executing the second memory operation that specifies a second category;
executing a second barrier instruction that specifies the second category;
determining that data associated with memory operations that specify the second category, including the second memory operation, is visible in the memory; and
subsequent to determining that the data associated with the second memory operation is visible in the memory, setting a flag to enable a second process to execute on the processor, wherein the second process accesses the data associated with the second memory operation.

7. The computer-implemented method of claim 1, further comprising:
executing the second memory operation that does not specify a category;
assigning a default category to the second memory operation;
executing a second barrier instruction that specifies the default category;
determining that data associated with memory operations that specify the default category, including the second memory operation, is visible in the memory; and
subsequent to determining that the data associated with the second memory operation is visible in the memory, setting a flag to enable a second process to execute on the processor, wherein the first process accesses the data associated with the second memory operation.

8. The computer-implemented method of claim 1, further comprising:
executing the second memory operation that does not specify a category;
executing a second barrier instruction that does not specify a category;
determining that data associated with all pending memory operations, including the second memory operation, is visible in the memory; and
subsequent to determining that the data associated with the second memory operation is visible in the memory, setting a flag to enable a second process to execute on the processor, wherein the first process accesses the data associated with the second memory operation.

9. One or more non-transitory computer-readable media storing program instructions that, when executed by one or more processors, cause the one or more processors to perform steps of:
executing a first memory operation that specifies a first category;
executing a first barrier instruction that specifies the first category;
determining that data associated with memory operations that specify the first category, including the first memory operation, is visible in a memory; and
subsequent to determining that the data associated with the first memory operation is visible in the memory, setting a flag to enable a first process to execute on a processor included in the one or more processors while a second memory operation is pending, wherein the first process accesses the data associated with the first memory operation.

10. The one or more non-transitory computer-readable media of claim 9, wherein the second memory operation specifies a second category that is different from the first category.

11. The one or more non-transitory computer-readable media of claim 9, wherein the second memory operation does not specify a category.

12. The one or more non-transitory computer-readable media of claim 9, wherein the second memory operation does not specify a category, and wherein the second memory operation is deemed to specify a default category that is different from the first category.

13. The one or more non-transitory computer-readable media of claim 9, wherein the second memory operation specifies a default category that is different from the first category.

14. The one or more non-transitory computer-readable media of claim 9, wherein the steps further comprise:
executing the second memory operation that specifies a second category;
executing a second barrier instruction that specifies the second category;
determining that data associated with memory operations that specify the second category, including the second memory operation, is visible in the memory; and
subsequent to determining that the data associated with the second memory operation is visible in the memory, setting a flag to enable a second process to execute on the processor, wherein the second process accesses the data associated with the second memory operation.

15. The one or more non-transitory computer-readable media of claim 9, wherein the steps further comprise:
executing the second memory operation that does not specify a category;
assigning a default category to the second memory operation;
executing a second barrier instruction that specifies the default category;
determining that data associated with memory operations that specify the default category, including the second memory operation, is visible in the memory; and
subsequent to determining that the data associated with the second memory operation is visible in the memory, setting a flag to enable a second process to execute on the processor, wherein the first process accesses the data associated with the second memory operation.

16. The one or more non-transitory computer-readable media of claim 9, wherein the steps further comprise:
executing the second memory operation that does not specify a category;
executing a second barrier instruction that does not specify a category;
determining that data associated with all pending memory operations, including the second memory operation, is visible in the memory; and
subsequent to determining that the data associated with the second memory operation is visible in the memory, setting a flag to enable a second process to execute on the processor, wherein the first process accesses the data associated with the second memory operation.

17. A system, comprising:
a memory storing instructions;
a first processor that is coupled to the memory and that executes processes for a second processor; and
the second processor that is coupled to the first processor and the memory and, when executing the instructions:
executes a first memory operation that specifies a first category;
executes a first barrier instruction that specifies the first category;
determines that data associated with memory operations that specify the first category, including the first memory operation, is visible in a memory; and
subsequent to determining that the data associated with the first memory operation is visible in the memory, sets a flag to enable a first process to execute on the first processor while a second memory operation is pending, wherein the first process accesses the data associated with the first memory operation.

18. The system of claim 17, wherein, when executing the instructions, the second processor further:
executes the second memory operation that specifies a second category;
executes a second barrier instruction that specifies the second category;
determines that data associated with memory operations that specify the second category, including the second memory operation, is visible in the memory; and
subsequent to determining that the data associated with the second memory operation is visible in the memory, sets a flag to enable a second process to execute on the first processer, wherein the second process accesses the data associated with the second memory operation.

19. The system of claim 17, wherein, when executing the instructions, the second processor further:
executes the second memory operation that does not specify a category;
assigns a default category to the second memory operation;
executes a second barrier instruction that specifies the default category;
determines that data associated with memory operations that specify the default category, including the second memory operation, is visible in the memory; and
subsequent to determining that the data associated with the second memory operation is visible in the memory, sets a flag to enable a second process to execute on the first processor, wherein the first process accesses the data associated with the second memory operation.

20. The system of claim 17, wherein, when executing the instructions, the second processor further:
executes the second memory operation that does not specify a category;
executes a second barrier instruction that does not specify a category;
determines that data associated with all pending memory operations, including the second memory operation, is visible in the memory; and
subsequent to determining that the data associated with the second memory operation is visible in the memory, sets a flag to enable a second process to execute on the first processor, wherein the first process accesses the data associated with the second memory operation.
